(19) United States
(12) Patent Application Publication
(10) Pub. No.: US 2008/0002412 A1
(43) Pub. Date: Jan. 3, 2008

(54) LIQUID CRYSTAL DISPLAY DEVICE

(76) Inventors: Toshiaki Tanaka, Kodaira (JP); Hiroki Kaneko, Hitachinaka (JP); Ikuo Hiyama, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/766,123

(22) Filed: Jun. 21, 2007

(30) Foreign Application Priority Data
Jun. 30, 2006 (JP) 2006-180637

(51) Int. Cl. F21V 7/00

(52) U.S. Cl. 362/307

(57) ABSTRACT

There is explored the structure of an illumination device having a board, an interconnection and a reflector plate arranged on the aforementioned board, an LED element connected to the aforementioned interconnection, and a transparent resin part sealing the aforementioned LED element; wherein the aforementioned transparent resin part has a recess in the top face and the aforementioned recess has a shape taking as the major axis some axial direction in the plane of the aforementioned board. Further, the structure of a liquid crystal display device using this illumination device is explored. With the illumination device or a liquid crystal backlight light source module, it is possible to implement a light source for implementing an area control function and having the required homogeneous brightness and chromaticity distribution.

### BACKGROUND OF THE INVENTION

1. Field of the Invention

The present invention pertains to the structure of an illumination device using LED (light emitting diode) elements and pertains in particular to the structure of liquid crystal display devices acting as the backlight of this illumination device.

The contents of the present invention can be applied as a the light source of an illumination device or as a backlight light source module applicable to a large-sized liquid crystal television set or a mid- or small-sized liquid crystal display device such as for a cellular phone or a Personal Computer.

2. Description of the Related Art

As the backlight light source of liquid crystal television sets representative of liquid crystal display devices, modules equipped with LED elements have in recent years come to be developed. Unlike small-sized liquid crystal display devices for mobile telephones and the like which are equipped with white LEDs using fluorescent material, in medium-sized and large-sized liquid crystal television sets, it has become essential to ameliorate the performance of displays having a wide color reproduction range and handling video that can be independently controlled at high speeds or handling high picture quality by equipping them with LED elements having the three primary colors red, green, and blue.

In JP-A-1998-173242, there is mentioned the completion, by providing a resin mold with a lens shape, of a structure, in a round-type LED lamp, with which it is easy to mix the respective emitted colors radiated from red, green, and blue LED elements. Also, since the emitted light brightness directly above the LED element is high, it is important for the emitted light strength to be high and become a maximum on the side situated at a wide angle from the center of the LED element. As against this, in JP-A-2003-8068 and JP-A-2003-8081, there is shown a structure in which a resin lens is placed on top of a package and there are mentioned details of making a design such that, optically, there is radiation in the horizontal direction or to the high-angle side. By providing a resin lens, it is possible to control the radiation angle distribution toward the high-angle side. Further, in JP-A-2004-319458, there is described, in an LED backlight module, the setting of a backlight structure in which the light quantity is a maximum for radiation angles equal to or greater than 45°, by providing a reflector plate having a salient part as the center of the LED element, providing an LED element on an oblique surface, or controlling the radiation angle via a prism.

### SUMMARY OF THE INVENTION

In the aforementioned JP-A-2003-8068, JP-A-2003-8081, and JP-A-2004-319458, attempts are made at controlling the radiation angle distribution of an element, but the cancellation of bright spots and chromaticity distribution is not sufficient, so it is not necessarily possible to provide a homogeneous and stable brightness distribution and chromaticity distribution. Also, since homogenization is sought by providing a reflector plate or the like, alignment with the element is difficult, so there arises the problem that it is not possible to sufficiently respond to the decline in light emission efficiency due to control of the radiation angle or coupling.

Further, attention is paid to each individual LED element only, in the aforementioned JP-A-1998-173242 regarding a single LED lamp and also, in the aforementioned JP-A-2003-8068, JP-A-2003-8081, and JP-A-2004-319458, but in case several LED elements are arranged as the backlight of a liquid crystal display device or the like, the interaction of the brightness distributions of each LED element must be taken into account. In particular, it can be considered that it is useful, from the perspective of backlight control and the like, to bring anisotropy to the emitted light distribution of LED elements.

The present invention is one that solves a certain problem, having for its object to provide backlight having optimal emitted light characteristics for liquid crystal display devices and the like, and using LED elements.

In the present invention for solving the aforementioned problems, there is chosen an illumination device structure having an interconnection board, a reflector plate arranged on the aforementioned interconnection board, an LED element arranged on the aforementioned interconnection board, and a transparent resin part sealing the aforementioned LED element; and having, by means of the fact that the aforementioned transparent resin part has a recess in the upper face of the aforementioned LED element and has an asymmetric shape in the longitudinal and transverse directions as seen in the upper face, or in the directions of coordinate axes x and y, the angular distributions of the radiation emitting light differing respectively with respect to the direction in which the emitted light component of the aforementioned LED element reflects on the lateral face of the recess domain, the direction at right angles to the aforementioned direction and a direction approximately at right angles thereto, and an anisotropic radiation angle distribution depending on the aforementioned respective directions. Also, there is chosen an illumination device structure in which, due to the fact that the aforementioned transparent resin part has a recess in the upper face of the aforementioned LED element, the aforementioned LED element has a maximum in the light emission strength in a direction having a prescribed oblique angle from the vertical direction with respect to the aforementioned board. Moreover, there is chosen an illumination device structure in which that component of the light emitted by the aforementioned LED element which is in a vertical direction with respect to the aforementioned board is completely reflected in the recess of the aforementioned transparent resin part. In addition, there is chosen an illumination device structure in which the aforementioned recess has an elliptical cone shape, or further a shape in which a plurality of cone lines are piled up, a shape consisting of curves whose curvature gradually changes and have smooth envelope curves, or a shape in which triangle poles are formed transversely.

The present invention has the structure of a liquid crystal display device equipped with light source modules with the aforementioned LED packages having the shape of the aforementioned transparent resin part. In the present invention, there is a package arrangement structure provided periodically with light sources with a package structure having a interconnection board, a reflector plate arranged on the aforementioned board, an LED element arranged on the aforementioned interconnection board, and a transparent resin part sealing the aforementioned LED element; and there is chosen, between the aforementioned packages, a liquid crystal illumination device structure comprising a backlight light source having a radiation angle distribution exhibiting a maximum in the emitted light strength in a direction having a prescribed oblique angle in the direction in which there is reflection on the recess domains of the transparent resin part. Further, there is chosen a liquid crystal illumination device structure comprising a backlight light source having a radiation angle distribution in which, in a direction at right angles, and in directions approximately at right angles, with the direction reflecting on the lateral face of the recess domain of the transparent resin part, there is a complete-reflection Lambertian distribution or the light has a radiation angle distribution close to complete reflection, one part of the aforementioned radiation angle distribution in the aforementioned direction being regulated and suppressed due to the shape of the aforementioned reflection plate, the aforementioned radiation angle distribution not showing the emitted light component for angles greater than or equal to a specified angle and the emitted light component being limited to the range of specified angles only.

According to the present invention, it is possible to bring anisotropy to the emitted light distribution of backlight using LED elements, and it is possible to provide a light source that is optimal for liquid crystal display devices and the like.

In the present invention, there will, regarding a package structure in which there an LED element serving as the light source of an illumination device or a liquid crystal display device is mounted, hereinafter be mentioned ways and means of solving the aforementioned problem by forming a structure on the basis of an optical calculation.

In the prior art, as for LED elements used in normal illumination devices and liquid crystal backlight devices, the round type or the surface mounting type was adopted. In these structures, there appear bright spots directly above the elements, so there was a tendency that the bright spot distribution and the chromaticity distribution ended up arising with the element as the center. Even when lining up the package structures, it is seen that there ends up occurring phenomena like nucleon-shaped, inhomogeneous bright spot irregularities and color irregularities in which the chromaticity differences depend on the area and become conspicuous.

Hereinafter, mention will be made of means for attaining, in the present invention, an optical distribution having anisotropy by means of the overall structure of the package. Based on the transverse direction and the longitudinal direction, or the horizontal direction and the vertical direction, it is possible to take the backlight light source to be an illuminating device having anisotropy, by providing an asymmetric structure. E.g., in the horizontal and transverse direction, the radiation angle distribution is extended to radiation angles greater than the direction vertical to the board and the distribution is made to have peak strength, and in the vertical and longitudinal direction, the radiation angle distribution is narrowed, so, depending on the use, it becomes valid to make the distribution into a diffuse one in which the radiation angles are restricted. As a result of this, in liquid crystal display devices, e.g. in large-sized liquid crystal television sets, area-restricted image display becomes possible by implementing, by means of an LED element, a backlight light source having an anisotropic radiation angle distribution. By devising the LED package so as to carry out the drive of lines connected sideways, scroll backlighting becomes possible. This can be handled by line-dividing the corresponding backlight light sources with respect to the screen, making the light sources light up, and scrolling. Scroll backlighting represents area control in liquid crystal display devices, the result being that an improvement in image quality based on area control can be noticeably aimed for.

By building in a packaged light source having a function capable of area control, not only can uniform brightness distribution and chromaticity distribution be attained, but further, video image quality improvements and aiming for a drive with low electric power consumption in the whole structure based on independent control also become possible.

### BRIEF DESCRIPTION OF THE DRAWINGS

FIG. 1 is a cross-sectional view showing the structure of a packaged light source in the prior art.

FIG. 2 is cross-sectional view showing the structure of a resin-sealed packaged light source with a molded part mounted, in an embodiment of the present invention.

FIG. 3 shows the structure of a packaged light source, wherein portion A is a top view in an embodiment of the present invention, portion B is a cross-sectional view in a horizontal and transverse direction, and portion C is a cross-sectional view in a vertical and longitudinal direction.

FIG. 4 shows the structure of a packaged light source, wherein portion A is a top view in an embodiment of the present invention, portion B is a cross-sectional view in a horizontal and transverse direction, and portion C is a cross-sectional view in a vertical and longitudinal direction.

FIG. 5 shows the structure of a package, wherein portion A is a cross-sectional view with an integrated reflector plate, portion B is a cross-sectional view of an LED element with respect to the package with an integrated reflector plate, portion C is a cross-sectional view showing the structure of a resin-sealed packaged light source, and portion D is a cross-sectional view showing the structure of a resin-sealed packaged light source with a molded part mounted.

FIG. 6 is a cross-sectional view showing the structure of a resin-sealed packaged light source with a molded part mounted, in an embodiment of the present invention.

FIG. 7 is a cross-sectional view showing the structure of a resin-sealed packaged light source with a molded part mounted, in an embodiment of the present invention.

FIG. 8 is a cross-sectional view showing the structure of a resin-sealed packaged light source with a molded part mounted, in an embodiment of the present invention.

FIG. 9 shows the structure of a package, wherein portion A is a cross-sectional view with an integrated reflector plate, portion B is a cross-sectional view showing the installation structure of an LED element with respect to the package with an integrated reflector plate, and portion C is a cross-sectional view showing the structure of a resin-sealed packaged light source with an integrated reflector plate.

FIG. 10 is a cross-sectional view showing the structure of an integrated resin-sealed packaged light source with a molded part mounted, in an embodiment of the present invention.

FIG. 11 is a cross-sectional view showing the structure of an integrated resin-sealed packaged light source with a molded part mounted, in an embodiment of the present invention.

FIG. 12 is a cross-sectional view showing the structure of an integrated resin-sealed packaged light source with a molded part mounted, in an embodiment of the present invention.

FIG. 13A is the calculated result of the radiation angle distribution of an LED element in a horizontal and transverse direction.

FIG. 13B is the calculated result of the radiation angle distribution of an LED element in a vertical and longitudinal direction.

FIG. 14A is the actually measured result of the LED element radiation angle distribution in a horizontal and transverse direction, in an embodiment of the present invention.

FIG. 14B is the actually measured result of the LED element radiation angle distribution in a vertical and longitudinal direction, in an embodiment of the present invention.

FIG. 15 shows the structure of a packaged light source, wherein portion A is a top view in an embodiment of the present invention, portion B is a cross-sectional view in a horizontal and transverse direction, and portion C is a cross-sectional view in a vertical and longitudinal direction.

FIG. 16A is the calculated result of the radiation angle distribution of an LED element in a horizontal and transverse direction.

FIG. 16B is the calculated result of the radiation angle distribution of an LED element in a vertical and longitudinal direction.

FIG. 17A is the actually measured result of the LED element radiation angle distribution in a horizontal and transverse direction, in an embodiment of the present invention.

FIG. 17B is the actually measured result of the LED element radiation angle distribution in a vertical and longitudinal direction, in an embodiment of the present invention.

FIG. 18 is a top view showing the structure of a packaged light source in an embodiment of the present invention.

FIG. 19 is a top view showing the structure of a backlight module in an embodiment of the present invention.

FIG. 20 is a top view showing the structure of a packaged light source in an embodiment of the present invention.

FIG. 21 is a top view showing the structure of a backlight module in an embodiment of the present invention.

FIG. 22A is the actually measured result of the LED element radiation angle distribution in a horizontal and transverse direction, in an embodiment of the present invention.

FIG. 22B is the actually measured result of the LED element radiation angle distribution in a vertical and longitudinal direction, in an embodiment of the present invention.

FIG. 23 is a cross-sectional view showing the structure of a backlight module light source and a liquid crystal display device, in an embodiment of the present invention.

FIG. 24 is a cross-sectional view showing the structure of a backlight module light source and a liquid crystal display device, in an embodiment of the present invention.

FIG. 25 is a top view showing the structure of a backlight module light source and a liquid crystal display device for small- and medium-sized equipment, in an embodiment of the present invention.

FIG. 26 is a top view showing the structure of a backlight light source and a drive device for an onboard car navigation system, in an embodiment of the present invention.

### DESCRIPTION OF THE EMBODIMENTS

Hereinafter, specific modes for implementing the present invention will be explained.

### First Embodiment

Using FIG. 1 to FIG. 14, Embodiment 1 of the present invention will be explained.

In the conventional example, as shown in FIG. 1, it is known, as light-emitting diode (LED) elements used as light sources of illumination devices or light source backlight modules, for the same to be integrated as a surface-mounted package structure. E.g., as shown in FIG. 1, an interconnection 2 is formed and a reflector plate 3 is structured in an integrated fashion on a metal board with an insulating layer included, a ceramic board, or a glass epoxy board 1. Next, there is taken an LED element 4 mounted by wire bonding based on a wire 5 shown in FIG. 1. Further, an LED light source with a surface-mounted package structure is prepared by means of sealing the LED element using a transparent resin part 6.

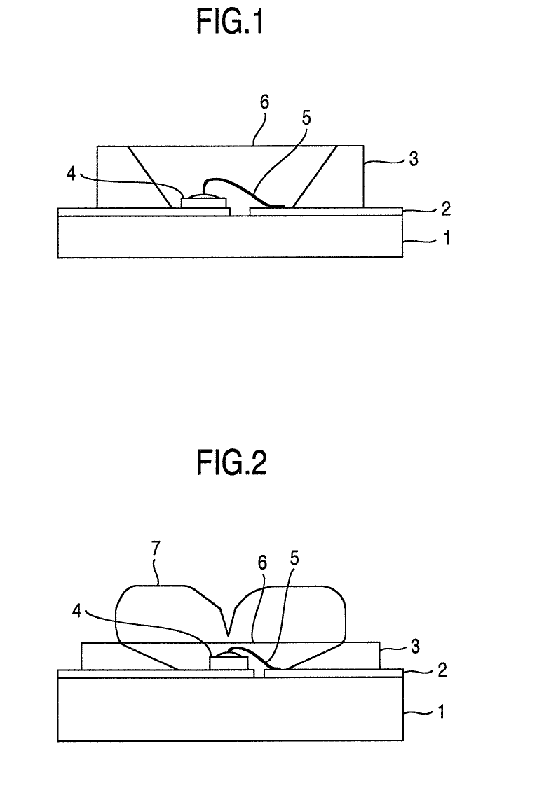

In the present embodiment, assuming a surface mounted package structure, in the same way as in the prior art example, after preparing up to transparent resin part 6, the LED element light source with a package structure is prepared by means of mounting with bonding on the top part of the package, and a separately prepared transparent resin part is obtained by shaping a transparent resin part 7. The LED element may, apart from the element mounted with wire bonding as shown in FIG. 1 and FIG. 2, be flip-chip mounted. The shaped transparent resin part 7 has a recess-shaped depression formed in its center part, there being carried out, in the peripheral part domain, a shape having a curve with a curvature and there being formed a structure capable of concentrating, in the peripheral parts, the emitted light components radiated by the LED element at high angles. The depth of this recess-shaped depression is taken to be as close as possible to the LED element and, as for the distance between the place of the maximum depth of the recess-shaped depression and the LED element, it is desirable to provide the depression by approaching to a distance being of the same extent as, or smaller than, the thickness of the element. Also, as for the width of the conical recess-shaped depression, it is desirable to set it to be greater than the width of the LED element. The vertex angle at the tip of the recess-shaped depression is regulated by design so as to completely reflect, from among the emitted light components of the LED element, a large portion of the emitted light components radiated at angles in a direction perpendicular, or nearly perpendicular, to the board, and to reflect the same toward higher angles. By means of transparent resin part 7 having this shape, the radiation angle distribution of the LED element, in the cross-sectional view shown in FIG. 2, has peak strength in a high-angle region differing from the vertical direction, and by means of regulating the shape of the molded part, it is possible to devise the package so as to set the angle exhibiting the peak strength to a prescribed value. In this way, it is possible, in the light source of an integrated illumination device or a liquid crystal backlight module, to implement an arrangement structure obtaining a homogeneous brightness distribution. The shape in the center part of transparent resin part 7 is the deepest at the center, and as shown in FIG. 2, for the oblique region, there can be set a line, to correspond to the targeted radiation angle distribution, which may be a straight line, a curve devised to superimpose the curves of a plurality of recess-shaped depressions, or a curve devised to have the shape of an envelope for which the sectional oblique regions of the recess-shaped depression are smooth.

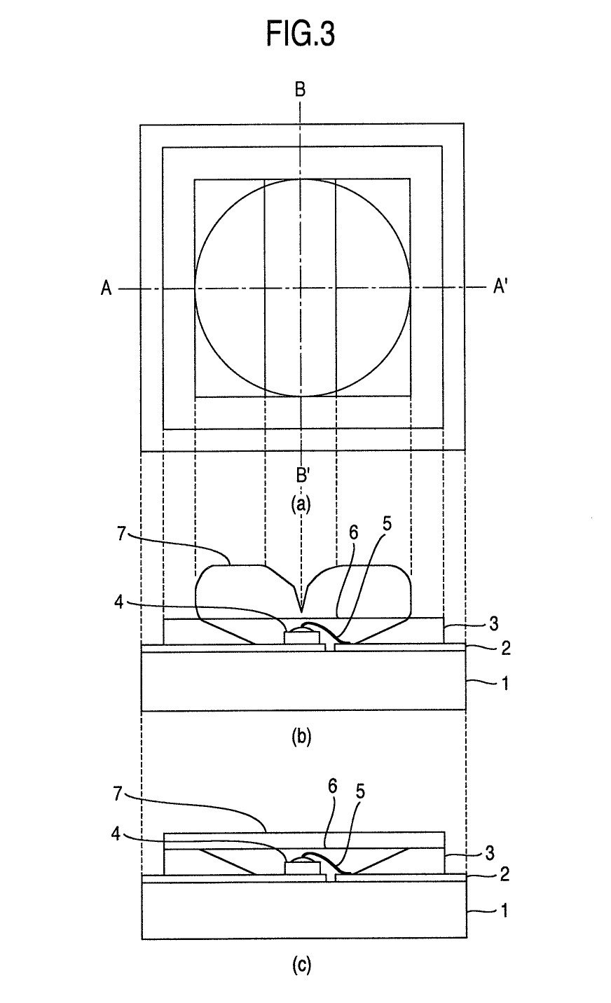

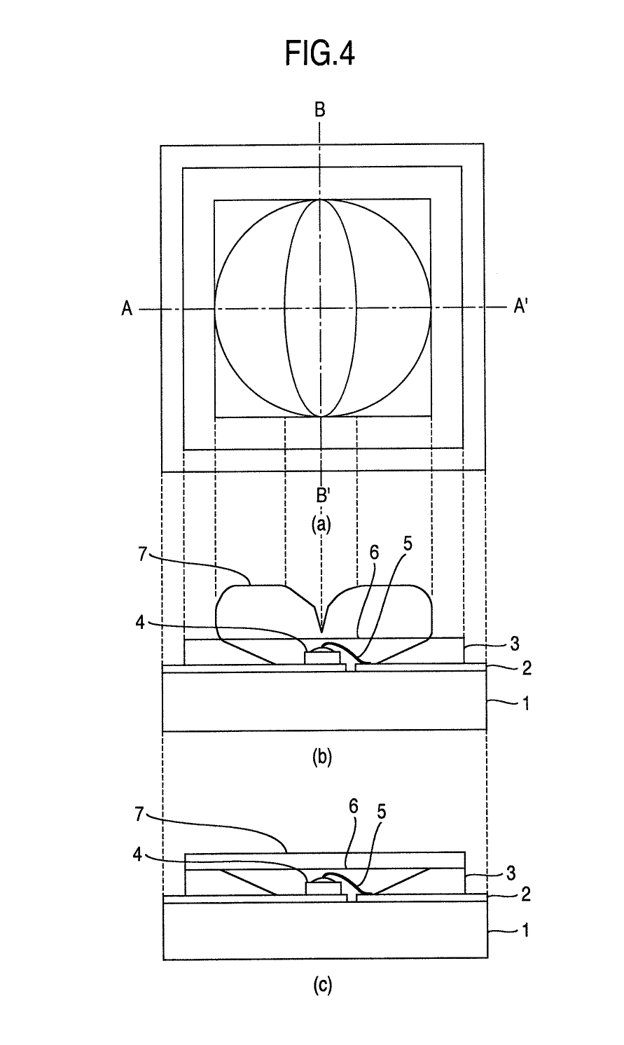

Regarding transparent resin part 7 having a shape, if the recess-shaped depression provided in the center part is taken to have a conical shape with point symmetry, it is possible, with the conical shape, to set the emitted light distribution of the LED element to be a radiation angle distribution with point symmetry. However, since, seen from the top face, different radiation angle distributions of the LED element cannot be obtained in the longitudinal direction and the transverse direction, or in the vertical direction and the horizontal direction, the following structure is implemented to handle this in the present embodiment. In FIGS. 3A, 3B, and 3C, the recess provided in the top face of transparent resin part 7 has a shape taking as the major axis some axial direction in the plane of board 1. Stated in greater detail, a structure is chosen in which, in the A-A′ line direction of the horizontal and transverse direction and the B-B′ line direction of the vertical and longitudinal direction, the shape of the recess of transparent resin part 7 is asymmetric. Due to the fact that this recess reflects the radiated light from LED element 4, the result is that LED element 4 has a maximum in the emitted light strength in a direction having a prescribed oblique angle from the direction which is vertical with respect to board 1. Further, due to the fact that the recess is processed into a shape having a major axis, the radiation angle distribution of LED element 4, the result is that the recess is anisotropic in the axial direction having a major axis. In FIGS. 3A, 3B, and 3C, in the direction of line A-A′ in the horizontal and transverse direction, there is no continuity regarding the shape of transparent resin part 7, and in the direction of line B-B′ in the vertical and longitudinal direction, the recess-shaped depression of the center part is provided rectilinearly, the shape being chosen to be continuous in the direction of line B-B′ in the vertical and longitudinal direction. In this way, the emitted light distribution of the LED element in the direction of line A-A′ in the horizontal and transverse direction, and the direction of line B-B′ in the vertical and longitudinal direction becomes asymmetric, so it is possible to bring anisotropy to the radiation angle distribution. As for the depression in the recess, there is taken, in FIGS. 3A, 3B, and 3C, a shape in which triangle poles are arranged transversely in the top face of transparent resin part 7, but the generating line of this triangle pole may be of a curved shape or, in addition, a shape in which the curvature of the generating line changes continuously. Further, as shown in FIGS. 4A, 4B, and 4C, even by conferring an elliptical cone shape to the depression in the recess, it is possible to bring the same result. Even in this case, the elliptical cone generating line may be of a curved shape or it may be of a shape in which the curvature of the generating line changes continuously. Further, the major axis direction of the recess stated in the specification of the present application indicates the pole direction of the triangle pole, i.e. the B-B′ direction, in the case of a recess shape in which a triangle pole is arranged transversely as shown in FIGS. 3A to 3C. Also, as shown in FIG. 4, in the case of an elliptical cone recess shape, the B-B′ direction is indicated. In the major axis direction of the recess, as to the shape of the transparent resin part, there are formed reflective and transmissive refractive faces. On the other hand, as against this, in the minor axis direction of the recess, the domains in which only faces which completely reflect are formed are in the transparent resin shape, and in the other domains, the invention is characterized by there being formed faces which reflect and transmit refractively.

In FIGS. 4A, 4B, and 4C, in the A-A′ line direction of the horizontal and transverse direction and the B-B′ direction of the vertical and longitudinal direction, the shape of transparent resin part 7 is taken to be asymmetric, but the recess-shaped depression provided in the center part is set to be an elliptical cone, seen from above, and the recess-shaped depression is prepared so as to have an elliptical cone shape. According to this shape, it is possible, in the elliptical cone shape, according to the ratio between the lengths of the long side and the short side of the ellipse, to regulate the extent of asymmetry regarding the emitted light distribution of the LED element in the direction of line A-A′ in the horizontal and transverse direction, and the direction of line B-B′ in the vertical and longitudinal direction. Together with bringing anisotropy to the radiation angle distribution of the element, there is brought the effect that it is possible to bring strength or weakness, and to add anisotropy, to the radiation angle distribution in response to the objective.

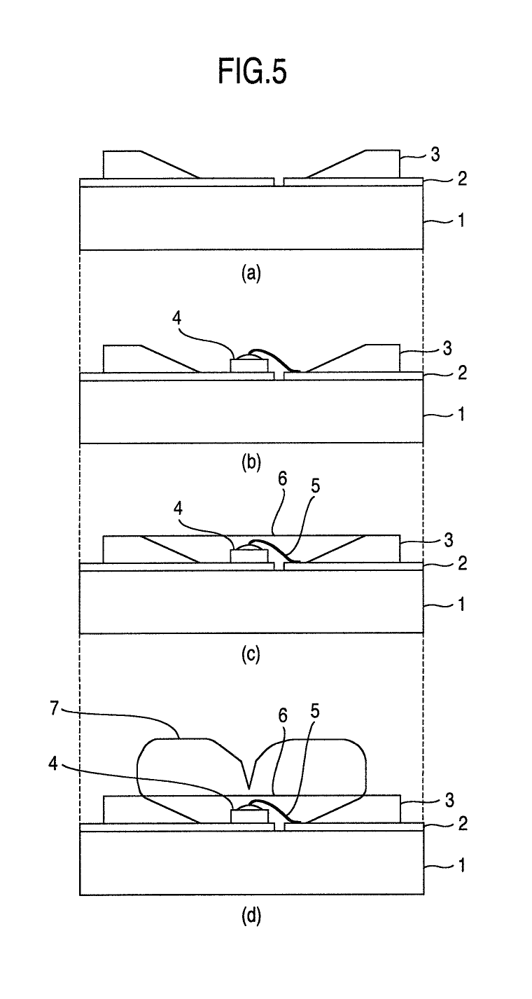

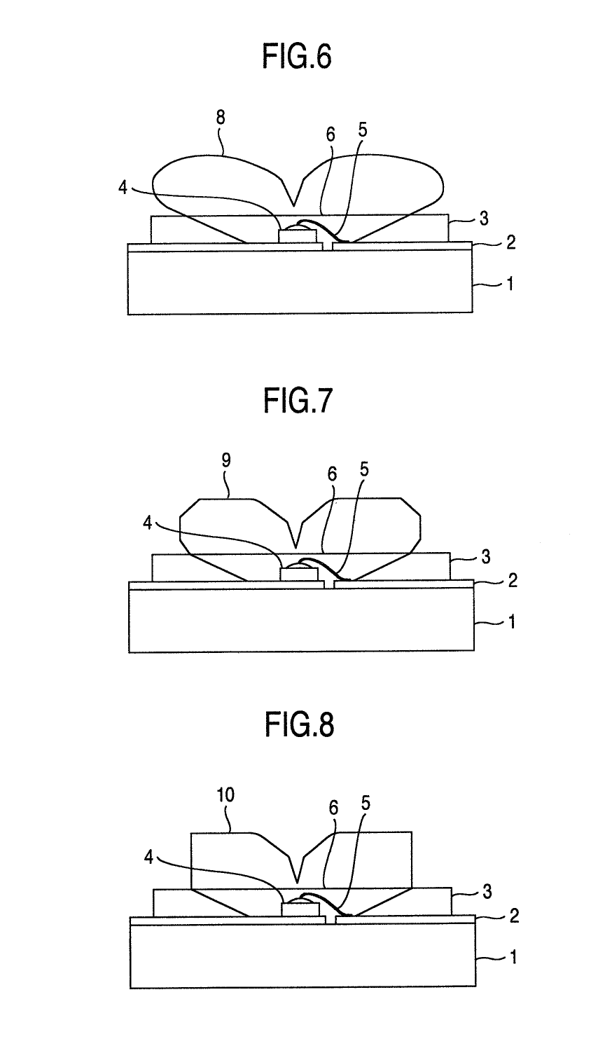

In FIGS. 5A, 5B, and 5C, there is shown an example of a production process of the present embodiment. In FIG. 5A, there is prepared, on a metal board with an insulating layer included, a ceramic board or an epoxy glass board 1, a piece wherein interconnection 2 is formed and reflector plate 3 is produced in an integrated fashion. Next, in FIG. 5B, LED element 4 is mounted by bonding by means of a gold wire 5. In FIG. 5C, LED element 4 is temporarily sealed by means of transparent resin part 6. In FIG. 5D, on this transparent resin part 6, in the form of mounting by bonding separately prepared transparent resin part 7, the shape of an embodiment of the present invention is obtained. A separately prepared molded piece can be set in various ways in response to the target radiation angle distribution. In FIG. 6, the shape of the recess-shaped depression is taken to be that of a smooth envelope, and also, there is set a shape taking the peripheral part of the lens collection domain to be a smooth envelope. In FIG. 7, there is set a shape of the recess-shaped depression and the peripheral part that is taken to be a folded line modified into a step shape with multiple stages. In FIG. 8, the shape of the recess-shaped depression is taken to be a folded line modified into a step shape with multiple stages, and the shape of the peripheral part is set to be that of a straight line. Transparent resin parts 8, 9, and 10 of FIG. 6, FIG. 7, and FIG. 8, can respectively, via the production processes of FIGS. 5A, 5B, and 5C, shape light sources with a package structure in the same way. The height of molded-part transparent resin parts 7, 8, and 9 provided on reflector plate 3 and transparent resin part 6 is in the range of 0.5 mm to 10 mm, the size is in a range roughly estimated to be between 1 mm and 30 mm and should be designed as a function of the use. Depending on the requirements associated with the use, sizes falling outside the aforementioned ranges may be acceptable.

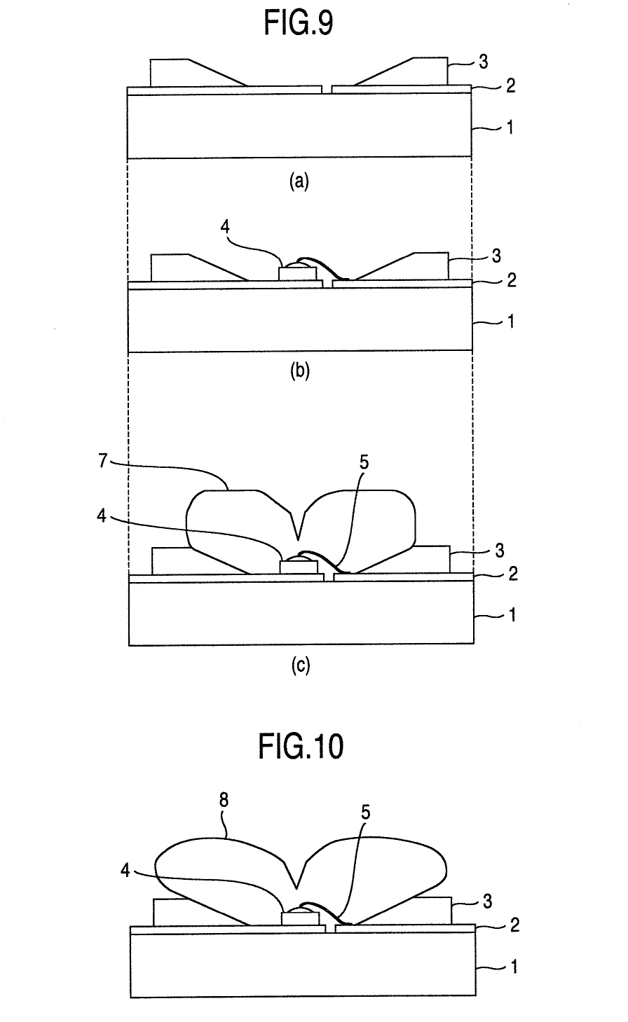

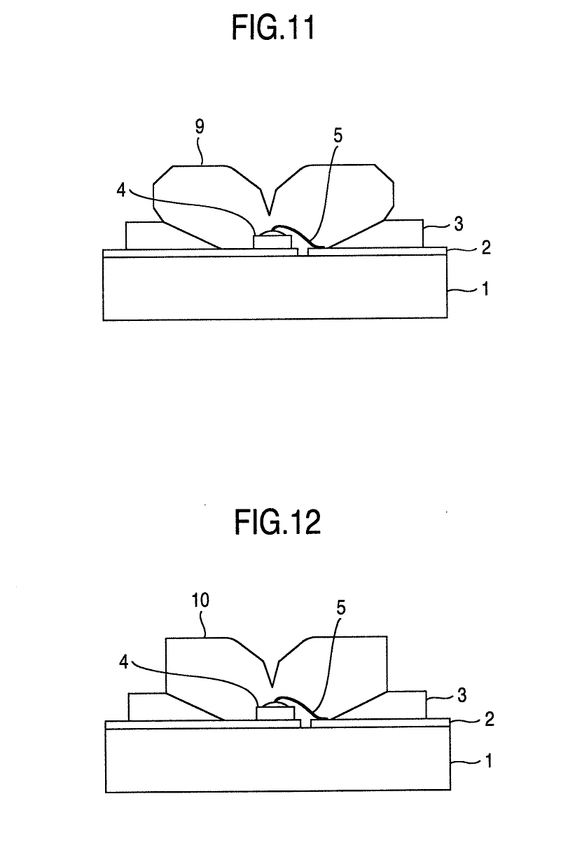

In FIGS. 9A, 9B, and 9C, the light source with a package structure is produced in the same way as in FIGS. 5A to 5D, but a shape is conferred to the transparent resin using a metal mold and a process of sealing the LED element is carried out. In FIGS. 9A to 9C, the same shape as for transparent resin part 7 in the aforementioned FIG. 5 is produced by means of a metal mold. In FIG. 10, FIG. 11, and FIG. 12, transparent resin parts 8, 9, and 10 in the aforementioned FIG. 6, FIG. 7, and FIG. 8 are respectively produced by means of a metal mold. In molded parts of transparent resin of the integrated type, it is a characteristic, since a difference in refractive index does not arise because they are of the same material, that the radiation angle distribution of the LED element is formed by means of smoother emitted light components. The height of integrally molded transparent resin parts 7, 8, 9, and 10 arising by protruding higher than reflector plate 3 is in the range of 0.5 mm to 10 mm, and the size of the protruding part is in a range roughly estimated to be between 1 mm and 30 mm and should be designed as a function of the use. Depending on the requirements associated with the use, sizes falling outside the aforementioned ranges may be acceptable.

Further, in the case of forming integrally molded transparent resin parts 7, 8, 9, and 10, the structure is one where reflector plate 3 is not particularly necessary since it is possible to directly mold a shape of an integrated molded part by means of a metal mold, and it never occurs that the functionality of the present invention is lost so it is acceptable to not necessarily provide reflector plate 3.

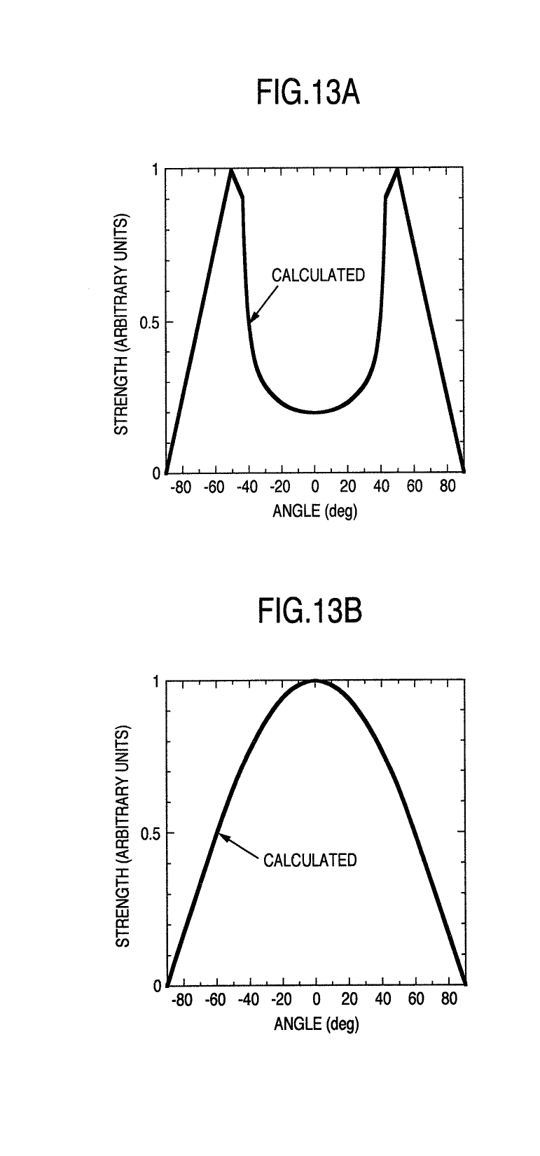

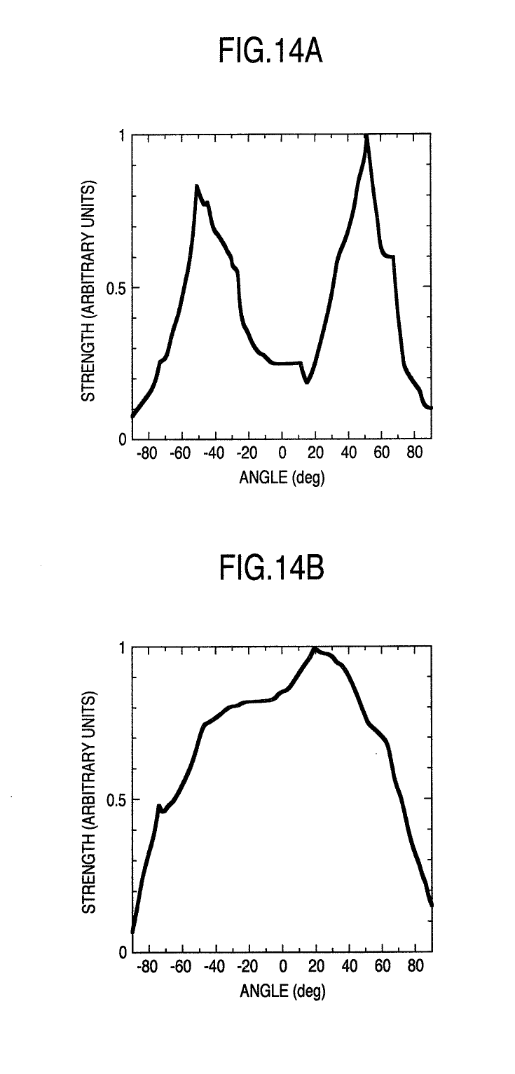

It is clear from calculation that the radiation angle distribution of an LED element according to the present embodiment, as shown in FIGS. 13A and 13B, can be obtained to have anisotropy. I.e., in the direction of transverse-direction line A-A′, there can, as shown in the calculation result of FIG. 13A, be obtained a radiation angle distribution having peak strength at a specific high angle which is higher than for a direction perpendicular to the board. The angle having this peak strength can be controlled by means of the forming conditions of the center part recess-shaped depression of the molded part. Moreover, in the direction of longitudinal-direction B-B′, since, as shown in FIG. 13B, there is no characteristic shape modifying the emitted light distribution of the LED element, a Lambertian diffusion distribution due to normal transparent resin is obtained. In the light source with a package structure based on the present embodiment, it is possible to produce, from one package structure, a radiation angle distribution having the anisotropy shown in FIGS. 13A and 13B. In practice, on the basis of the aforementioned design, in an example of a resin shape produced following the aforementioned process, it has been possible to obtain the radiation angle distribution shown in FIGS. 14A and 14B. I.e., in the direction of line A-A′ in the transverse direction shown in FIG. 3A and FIG. 4A, it has been possible to choose the radiation angle distribution of FIG. 14A having the peak strength on the high-angle side, so as to correspond to the design of FIG. 13A, and in the direction of line B-B′ in the longitudinal direction shown in FIG. 3A and FIG. 4A, it has been possible to choose the radiation angle distribution of FIG. 14B which turns out to be a diffuse light distribution, so as to correspond to the design of FIG. 13B. In this way, it was possible to attain radiation angle distributions with strong anisotropy in the transverse direction and the longitudinal direction.

According to the present embodiment, in an illumination device or a liquid crystal backlight device, it is possible, together with extending the radiation angle distribution of the LED element, to strive for the homogenization of the brightness and the chromaticity, with the smallest possible quantity of packages in the transverse direction. In the longitudinal direction, it also becomes possible to set the radiation angle distributions of package-structure LED light sources so that emitted light distributions of the packages do not overlap much. In this way, it is possible to provide, depending on the objective, an optimal LED light source for carrying out control of an irradiated area of an illumination device or an area associated with the drive of a liquid crystal backlight. Further, according to the size of the illumination device or the liquid crystal display device, it is possible to appropriately set the quantity of packages or the shape of the sealing resin and to strive for the homogenization of the brightness or the chromaticity in the package structure as a whole. In this way, it is possible, by implementing the homogenization of the brightness and the chromaticity with the smallest possible number of packages, to obtain an illumination device or a liquid crystal backlight module with low power consumption. By applying a structure an optimal/minimal number and optimal arrangement of elements, the invention also has validity with respect to cost-reducing technology based on the reduction of packages or elements.

The LED element package structure of the present embodiment applies not only to illumination devices or liquid crystal display device backlight modules for television sets in small to large sizes but also liquid crystal panels for Personal Computers or backlight light sources of car navigation systems, and further, even to light sources for onboard uses.

### Second Embodiment

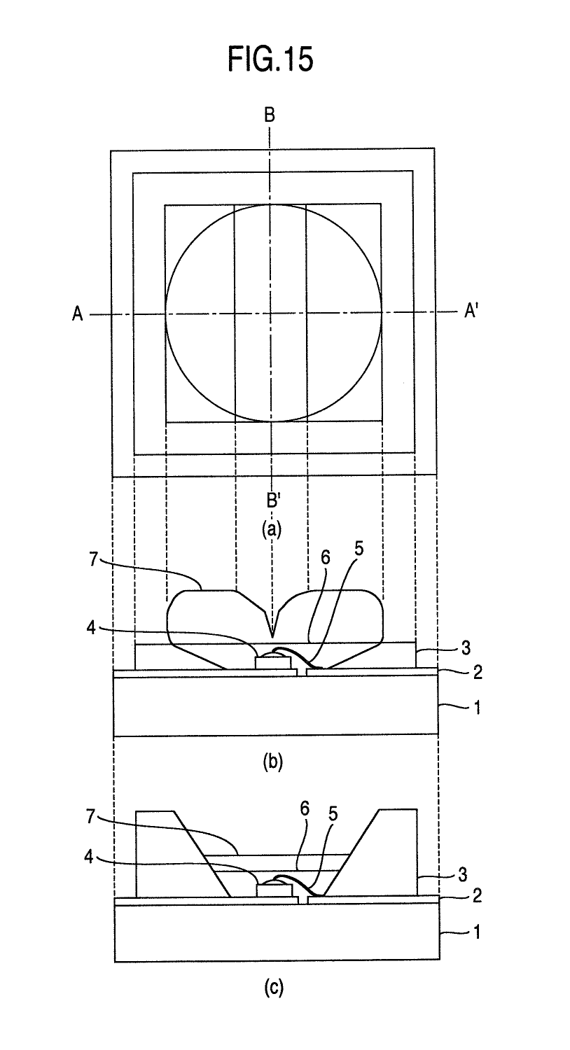

Using FIG. 15 to FIG. 17, Embodiment 2 of the present invention will be explained.

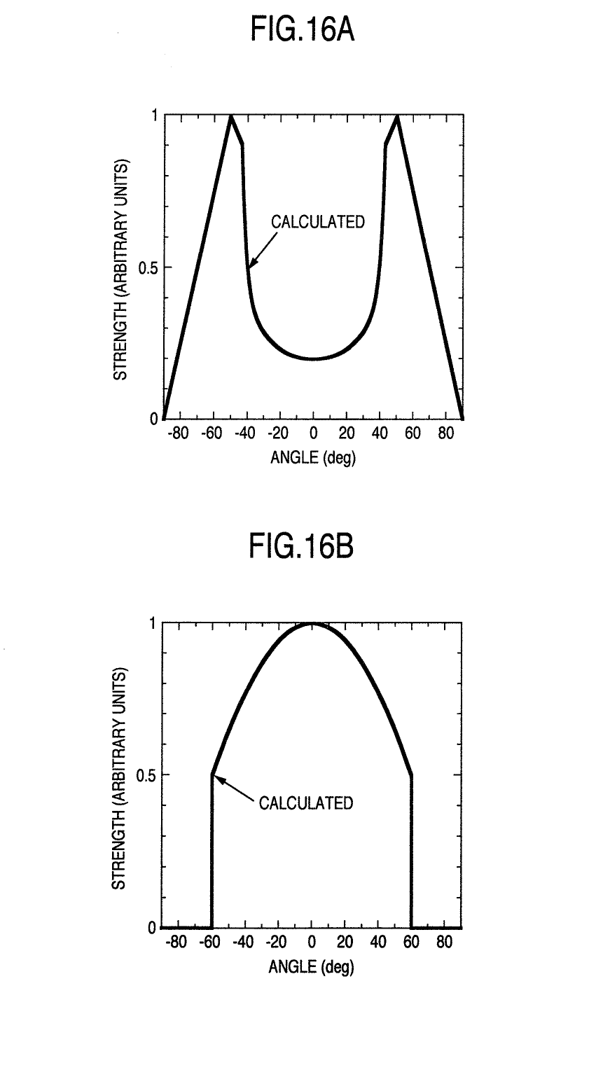

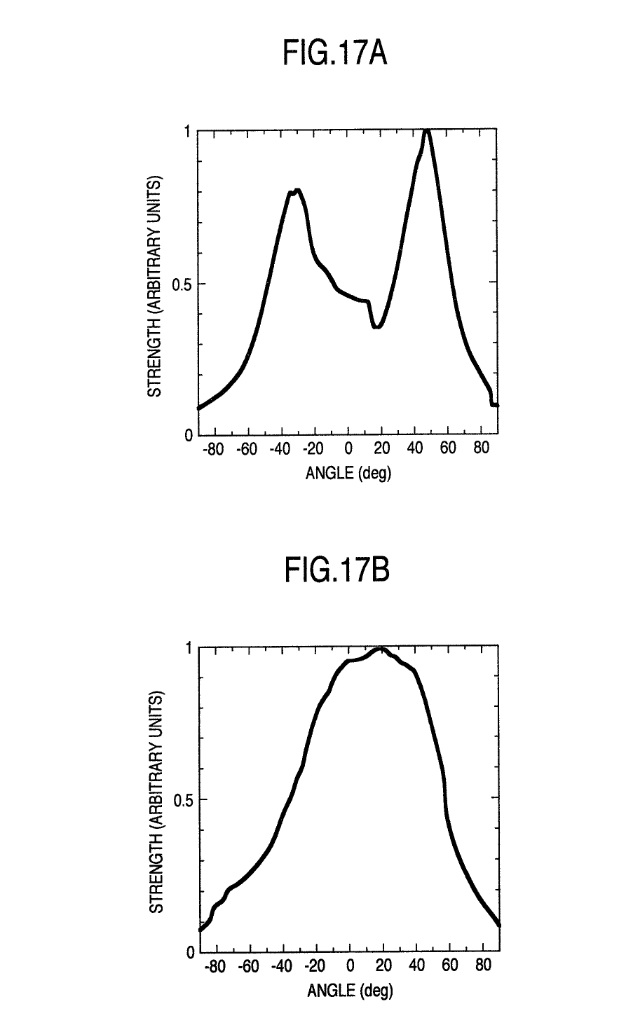

In the present embodiment, exactly in the same way as for Embodiment 1, an LED light source with a package structure is produced, but, as shown in FIGS. 15A, 15B, and 15C, after producing a package structure, reflector plate 3 shown in the cross section of FIG. 15C is set to be higher than LED element 4, and is set so as to be on the same order as, or greater than, the height of transparent resin part 7 formed with transparent resin. In this way, with respect to a specific direction, the height of the reflector plate is made to correspond and the emitted light distribution of the LED element is controlled, the shape of the radiation angle distribution is controlled. As for the radiation angle distribution of the LED element obtained with the present embodiment, it is clear that, by calculation, it can be obtained having anisotropy, as shown in FIGS. 16A and 16B. I.e., in the direction of line A-A′ in the transverse direction, as shown to be the same as the calculated result of FIG. 16A, there can be obtained a radiation angle distribution having peak strength at a specific, higher angle than the direction which is perpendicular to the board. The angle having this peak strength can be controlled by the formation conditions of the recess-shaped depression of the center part of a molded part. On the other hand, in the direction of line B-B′ in the longitudinal direction, since, as shown in FIG. 15B, there is no characteristic shape that changes the emitted light distribution of the LED element, a Lambertian diffuse distribution based on normal transparent resin can be obtained, but, as provided in the present embodiment, there results a shape in which ideally the emitted light distribution is suppressed at high angles, since the normal diffuse distribution is screened at high angles by the height of the reflector plate. In the light source of a package structure according to the present embodiment, it is possible to produce a distribution of radiation angles having the anisotropy shown in FIGS. 16A and 16B from one package structure. In practice, it was possible to obtain the radiation angle distributions shown in FIGS. 17A and 17B, on the basis of the aforementioned designs, in an example of a resin shape produced following the aforementioned processes. I.e., in the direction of line A-A′ in the transverse direction shown in FIG. 15A, there can be chosen a radiation angle distribution of FIG. 17A having peak strength on the high-angle side so as to correspond to the design of FIG. 16A, and in the direction of line B-B′ in the longitudinal direction shown in FIG. 15A, it has been possible, so as to correspond to the design of FIG. 13B, to choose a radiation angle distribution of FIG. 17B which is a diffuse light distribution and which takes a form in which the strength on the high-angle side is suppressed. In this way, it has been possible, in the transverse direction and the longitudinal direction, to attain a radiation angle distribution with high anisotropy.

According to the present embodiment, in an illumination device or a liquid crystal backlight device, it is possible, together with extending the radiation angle distribution of an LED element, to strive for the homogenization of brightness and chromaticity, with the smallest possible quantity of packages, in the transverse direction. In the longitudinal direction, it is also possible to set the radiation angle distribution of package-structure LED light sources so that the emitted light distributions of the packages do not overlap much, and since the emitted light distribution on the high-angle side is suppressed, the radiation angle distribution between packages is regulated aptly, so it becomes possible to set the emitted light distributions so that the emitted light strength on the border becomes homogenous. It is possible to regulate the emitted light distribution to be more restricted in the longitudinal direction than in the case of Embodiment 1 and it has become possible to reduce the overlap of radiation angle distributions between modules.

In this way, in an LED light source with a package structure, the invention works advantageously with respect to aptly designing an arrangement of the packages based on a regulation of the emitted light distributions and the setting of the border domains between packages, based on a regulation of the light strength distributions. In the present embodiment, the invention is one which makes it possible to control, more homogenously and accurately, scrolling-based backlighting in a liquid crystal display device, in particular more than the package structure occurring in Embodiment 1. As shown hereby, the radiation angle distribution of the element in the present embodiment is very valid for a backlight light source module of an illumination device or a liquid crystal display device that should be controlled to the desired specification.

The LED element package structure of the present embodiment is similar to that of Embodiment 1 from the aspect of uses and can be applied not only to a backlight module light source of a an illumination device or devices ranging from a small-sized to a large-sized television liquid crystal display device but also to a liquid crystal panel for Personal Computers and to a backlight light source for a car navigation system, and further to a light source for onboard use.

### Third Embodiment

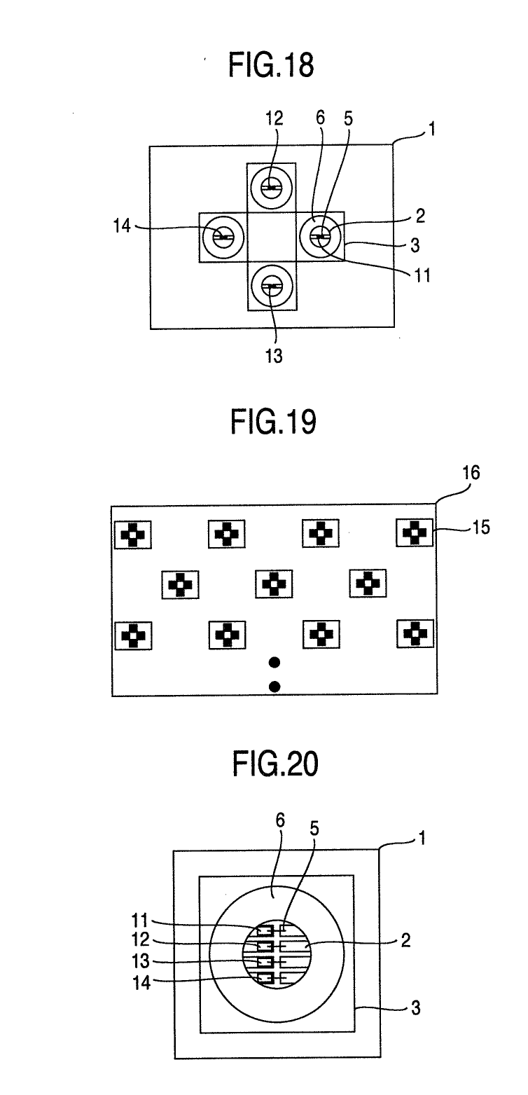

Using FIG. 18 to FIG. 24, Embodiment 3 of the present invention will be explained.

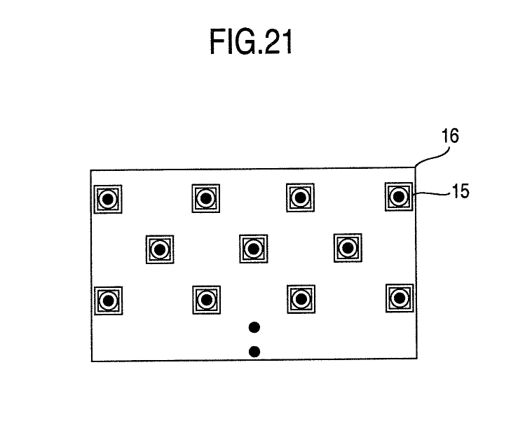

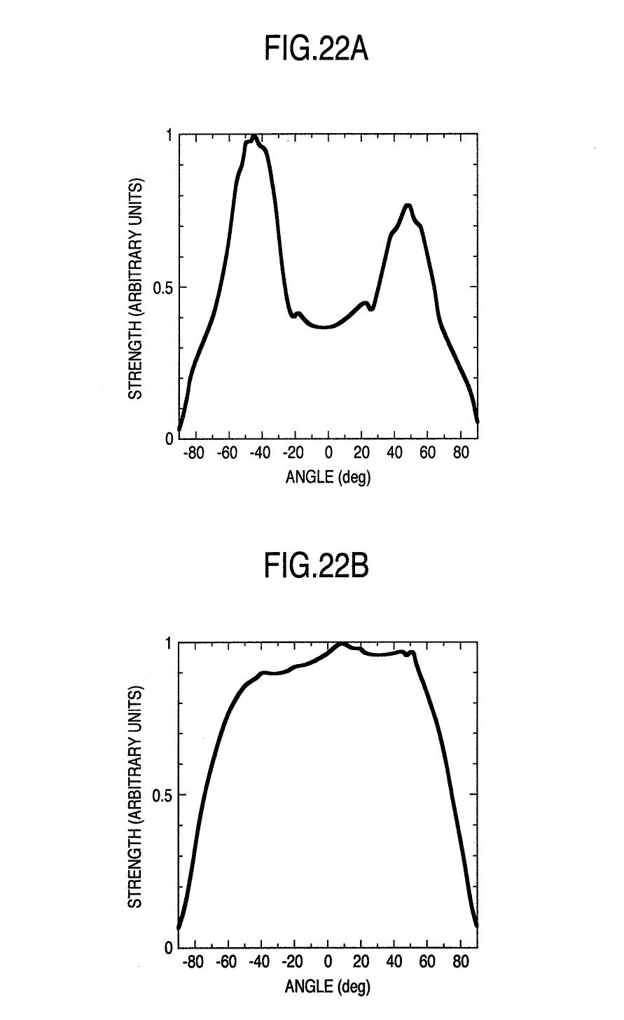

In the present embodiment, indications are given regarding the structure of a packaged light source and a liquid crystal backlight light source module. In the package structure of the present embodiment, there are cases where there are chosen four independently configured packages handling each of four elements, a red LED element 11, a green LED element 12, a green LED element 13, and a blue LED element 14, as shown in FIG. 18, and each packaged light source 15 is arranged in a backlight module housing 16 as shown in FIG. 19; and there are cases where red LED element 11, green LED element 12, green LED element 13, and blue LED element 14 are integrated into the same package, as shown in FIG. 20, and each package 15 is arranged in a backlight module housing 16, as shown in FIG. 21. It is possible to make the structure and arrangement of the packages correspond to a target specification. In either case, the emitted light distribution of the LED elements can be set to be asymmetric, so it is possible to apply the embodiment so that there is exhibited a radiation angle distribution exhibiting anisotropy. In the LED packages and backlight modules of FIG. 18 and FIG. 19, it is possible to respond by applying the LED light source packages appearing in Embodiments 1 and 2 respectively to red LED element 11, green LED element 12, green LED element 13, and blue LED element 14. By performing, with good accuracy, the alignment occurring at the time of installation and the alignment occurring at the time of mounting the shaped resin part shown in Embodiments 1 and 2 for the LED packages and backlight modules of FIG. 20 and FIG. 21 with respect to LED element 11, green LED element 12, green LED element 13, and blue LED element 14, respectively, not only is it possible to control the radiation angle distribution respectively for each of the four RGGB elements, but it is also possible to control the radiation angle distribution even in the case of taking a white element, for which a white color is chosen by operating each RGGB element and mixing the colors thereof. In practice, on the basis of the design, in an example in which there is mounted a shaped resin part on which each RGGB element is installed, it has been possible to obtain the radiation angle distribution shown in FIGS. 22A and 22B. I.e., in the transverse direction shown in FIG. 20, has been possible to choose the radiation angle distribution of FIG. 22A having peak strength on the high-angle side, so as to correspond to the design, and in the longitudinal direction shown in FIG. 20, it has been possible to choose the radiation angle distribution of FIG. 22B which, in order to correspond to the design, takes the form of a diffuse light distribution. In this way, it has been possible, even when it comes to white light in which each RGGB element is operated and the colors thereof are mixed, to attain a radiation angle distribution with strong anisotropy, in the transverse direction and the longitudinal direction.

As far as the practical uses are concerned, since the sizes, utilization conditions, etc., of liquid crystal panel display devices differ, it is possible to set the needed backlight module light source specification to the desired conditions by striving for appropriate design and structure so that the radiation angle distribution design and the installation of elements, as well as the shape control of the sealant resin correspond.

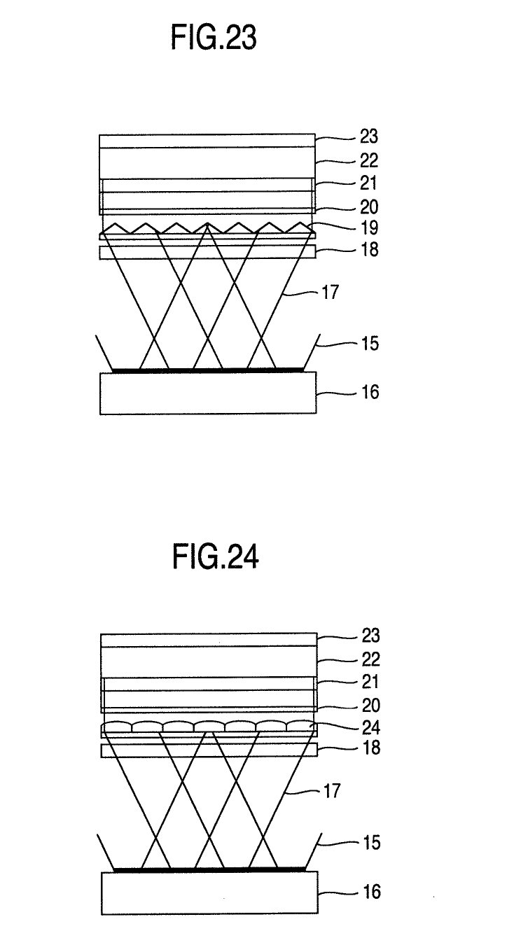

In the present embodiment, there is configured a liquid crystal panel display device using the aforementioned packaged light source. As shown in FIG. 23, after loading by mounting packaged light source 15 on backlight module housing 16, an optical system for a liquid crystal panel, such as an optical sheet is mounted, and there is produced a liquid crystal display device by combining the optical system and the liquid crystal panel. A light beam 17 emitted from the backlight module light source is transmitted through a diffuser plate 18, a prism sheet 19, a diffuser film 20, and the liquid crystal display panel. The liquid crystal panel has a pair of glass plates, a liquid crystal layer 22 arranged between this pair of glass plates, and a polarizing plate 21 and a polarizing plate 23 provided respectively to the pair of glass plates. Although, omitted in FIG. 23, there are included, on this liquid crystal display panel, a plurality of scan lines arranged in a transverse direction with respect to the display face, a plurality of signal lines arranged in a direction intersecting at right angles this plurality of scan lines, i.e. in a longitudinal direction with respect to the display face, and a plurality of switching elements arranged at the intersecting parts of this plurality of scan lines and this plurality of signal lines. At this juncture, it is possible to improve the brightness distribution and chromaticity distribution homogeneity of the component as a module packaged light source by controlling by design the radiation angle distribution, depending on the distance between the packaged light source and the diffuser plate. In the structure of FIG. 24, it is set in the same way as the structure of FIG. 23, but among the optical sheets, prism sheet 19 is replaced with a lenticular lens sheet 24. Due to the lenticular lens, there is the effect of improving the brightness in the frontal direction. Moreover, it is also possible to integrate a diffuse reflector film on the bottom face of the lenticular lens sheet. By pasting a diffuse reflector film to the bottom face of the lenticular lens sheet, associating this with the domain serving as a lens, and setting the diffuse reflector film having a slit shape in the same domain, it is also possible to improve the brightness of the radiation distribution component incident on the lens in the frontal direction of the liquid crystal panel. By making the radiation distribution component which is not directly incident on the lens be reflected by means of a diffuse reflector film, mixing the emitted light distribution, and once again making it incident on the lens, it is possible to bring an improvement in the brightness in the frontal direction. By means of these measures, it is possible to put to valid practical use the outgoing light beams of the backlight light source, and it is possible to implement a backlight module with a higher efficiency. Also, the controllability with respect to the homogeneity of the brightness distribution and the chromaticity distribution can be improved. The result is that, depending on the size and the conditions of use etc. of the liquid crystal panel display device, it is possible to correspondingly set the required backlight module light source specification desired conditions with relative ease.

According to the present embodiment, the light strength distributions can be extended and by using a plurality of packages using molded resin, it becomes possible to complement the mutual package light strength distributions. This has as a result that a plurality of package elements are applied and a structure which is adapted to a light source module for obtaining homogeneous brightness in the plane over a larger area. According to the present embodiment, in an illumination device or a liquid crystal backlight device, it is possible, together with extending the radiation angle distribution of an LED element in a horizontal and transverse direction, to strive for the homogenization of the brightness and the chromaticity by means of a minimal quantity of packages.

Stated in greater detail, it is possible to confer a shape wherein the direction in which the signal lines of the liquid crystal display panel are arranged is taken to be the major axis to the recess formed in the LED element of packaged light source 15. In this way, the result is that the radiation angle distribution of the LED element has anisotropy in the direction of the scan lines. I.e., as for the LED element, it is possible to enlarge the width of the light in the direction of the scan lines, the longitudinal direction, as compared to the direction of the signal lines, the longitudinal direction, so it becomes possible to set the radiation angle distribution of the package structure LED light source so that, in the longitudinal direction, there is not much overlap between the packages. Further, since the emitted light distribution on the high-angle side is suppressed, it becomes possible to make a setting so that the radiation angle distribution is aptly regulated among the packages and the emitted light strength at the borders becomes homogeneous. In this way, when it comes to LED elements with a package structure, this works advantageously with respect to progressively designing aptly the arrangement of packages on the basis of a regulation of the emitted light distribution and the setting of boundary domains between packages on the basis of a regulation of the light strength distribution. In the present embodiment, particularly in the case of exploring a structure in which the backlight of a liquid crystal display device is progressively scrolled in the longitudinal direction, there can be implemented LED elements with small mutual interference of light in the longitudinal direction and it is made possible to control the backlight more homogeneously and accurately. As shown hereby, as for the radiation angle distribution of the elements in this embodiment, it is shown that it is very valid for backlight light source modules of illumination devices and liquid crystal display devices which should be controlled to a desired specification.

The LED element package structure of the present embodiment is similar to those of Embodiments 1 and 2 from the aspect of uses and can be applied not only to a backlight module light source of a an illumination device or devices ranging from a small-sized to a large-sized television liquid crystal display device but also to a liquid crystal panel for Personal Computers and to a backlight light source for a car navigation system, and further to a light source for onboard use.

### Fourth Embodiment

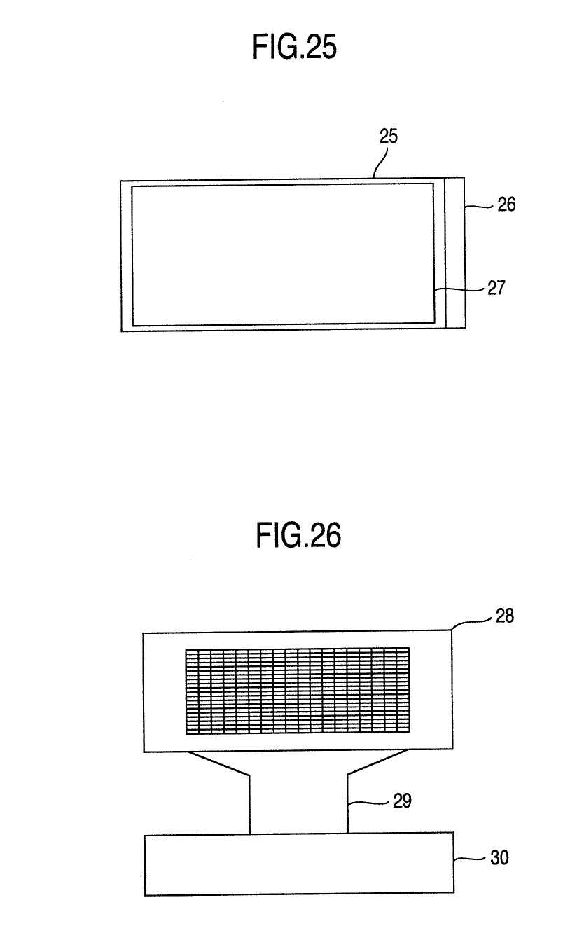

Using FIG. 25 and FIG. 26, Embodiment 4 of the present invention will be explained.

From the aspect of uses, the present embodiment can be applied in the same was as the aforementioned embodiments, but not only is application as a liquid crystal panel display device for mid-sized to large-sized television sets and a backlight module possible, but application as a backlight module down to the domains of small-sized and mid-sized display devices is also possible. In particular, even in the case of configuring the backlight module of a liquid crystal display panel with a comparatively large ratio of the lengths in the longitudinal directions and transverse directions, there is the advantage of being able to sufficiently handle the design, and it is possible to configure a backlight module by means of a practically minimal number of LED packages.

In FIG. 25, there are shown an LED backlight light source module 25, a backlight housing 26, and a small-sized liquid crystal display panel 27. Also, in FIG. 26, there is shown a liquid crystal display device for on-board car navigation which is constituted by incorporating a liquid crystal display panel 28 including a backlight module and an optical system, a circuit interconnection 29, and a drive circuit 30. By means of the present invention embodiment, it is possible, even if the size of the liquid crystal display device is reduced to a small size, to ensure the required homogeneity of the brightness distribution and the chromaticity distribution by making a backlight module in which the radiation angle distribution is controlled function.

It should be further understood by those skilled in the art that although the foregoing description has been made on embodiments of the invention, the invention is not limited thereto and various changes and modifications may be made without departing from the spirit of the invention and the scope of the appended claims.

1. An illumination device having:
a board,
an interconnection and a reflector plate arranged on said board,
an LED element mounted and connected to said interconnection,
and a transparent resin part sealing said LED element;
wherein:
said transparent resin part has a concave on recess on the top face and said recess has a shape taking as the major axis some axial direction in the plane of said board.

2. The illumination device according to claim 1, wherein said LED element, by means of the fact that said recess reflects the radiated light from said LED element, has a maximum value of the emitted light strength in a direction having a prescribed oblique angle from a vertical direction with respect to said board.

3. The illumination device according to claim 1, wherein the radiation angle distribution of said LED element is anisotropic in an axial direction in which said recess has a major axis.

4. The illumination device according to claim 1, wherein the depression in said recess has an elliptical cone shape.

5. The illumination device according to claim 4, wherein said elliptical cone shape has a generating line that is curved.

6. The illumination device according to claim 5, wherein the generating line of said elliptical cone shape changes continuously.

7. The illumination device according to claim 1, wherein the depression in said recess has a triangle pole shape.

8. A liquid crystal display device having a liquid crystal display panel having:
a pair of glass plates,
a liquid crystal layer arranged between said pair of glass plates,
polarizing plates respectively provided to said pair of glass plates,
a plurality of scan lines,
a plurality of signal lines arranged in a direction intersecting said plurality of scan lines at right angles,
and a plurality of switching elements arranged at the intersecting parts of said plurality of scan lines and said plurality of signal lines; and
an illumination device comprising:
a board,
an interconnection and a reflector plate arranged on said board,
an LED element mounted and connected to said interconnection,
and a transparent resin part sealing said LED element;
wherein:
said transparent resin part has a concave on recess on the top face and said recess has a shape taking as the major axis some axial direction in the plane of said board.

9. The liquid crystal display device according to claim 8, wherein said recess has a shape taking as the major axis the direction in which said signal lines are arranged.

10. The liquid crystal display device according to claim 8, wherein the radiation angle distribution of said LED element is anisotropic in the direction of said scan lines.

11. The liquid crystal display device according to claim 8, wherein said LED element has light whose width in the direction of said scan lines is larger, compared to the direction of said signal lines.

12. An illumination device having:
a board,
an interconnection and a reflector plate arranged on said board,
an LED element connected to said interconnection,
a first transparent resin part sealing said LED element,
and a second transparent resin part bonded to the top part of said first transparent resin part;
wherein:
said second transparent resin part has a recess on the top face
and said recess has a shape taking as the major axis some axial direction in the plane of said board.

13. The illumination device according to claim 12 wherein said LED element, by means of the fact that said recess reflects the radiated light from said LED element, has a maximum value of the emitted light strength in a direction having a prescribed oblique angle from a vertical direction with respect to said board.

14. The illumination device according to claim 12, wherein the radiation angle distribution of said LED element is anisotropic in an axial direction in which said recess has a major axis.

15. The illumination device according to claim 12, wherein the depression in said recess has an elliptical cone shape.

16. The illumination device according to claim 15, wherein said elliptical cone shape has a generating line that is curved.

17. The illumination device according to claim 16, wherein the generating line of said elliptical cone shape changes continuously.

18. The illumination device according to claim 12, wherein the depression in said recess has a triangle pole shape.
